(19) United States
(12) Patent Application Publication
(10) Pub. No.: US 2016/0203699 A1
(43) Pub. Date: Jul. 14, 2016

(54) METHOD AND APPARATUS OF SURVEILLANCE SYSTEM

(71) Applicant: YYESIT, LLC, Frederick, MD (US)

(72) Inventors: Paul Mulhern, Frederick, MD (US); Eliot Siegel, Frederick, MD (US); Yelena Yesha, Frederick, MD (US)

(73) Assignee: YYESIT, LLC, Frederick, MD (US)

(21) Appl. No.: 15/078,649

(22) Filed: Mar. 23, 2016

Related U.S. Application Data
(63) Continuation-in-part of application No. PCT/US2015/010334, filed on Jan. 6, 2015.
(60) Provisional application No. 61/923,992, filed on Jan. 6, 2014.
(60) Provisional application No. 62/077,609, filed on Nov. 10, 2014.

(51) Int. Cl. G08B 23/00; G08B 5/22; G08B 3/10

(52) U.S. Cl. CPC G08B 23/00; G08B 3/10; G08B 5/22

(57) ABSTRACT

The present invention relates to a method and apparatus of electronic surveillance, which employs data gathering devices that continuously collect and relay data (such as images and sounds) to a processor, which analyzes and compares the analyzed data to data samples stored in a catalog, interpreting the data in real time, and if a closely correlated data sample is identified by the program, and if that correlation has a feedback command associated with it in the feedback command catalog, then the program will issue a feedback command to at least one of a specific combination of data feedback devices, and/or may inform users using electronic methods. The present invention is used to track and provide feedback with various quality and safety measures for various activities in diverse environments, such as prisoner management, elder or children's care, or compliance in health care or in the food industry including hand washing behavior.

### CROSS-REFERENCE TO RELATED APPLICATIONS

The present application is a bypass continuation-in-part of International Application No. PCT/US2015/010334, filed Jan. 6, 2015, which claims priority from U.S. Provisional Patent Application No. 61/923,992 filed Jan. 6, 2014, and U.S. Provisional Patent Application No. 62/077,609, filed Nov. 10, 2014, the contents of all of which are herein incorporated by reference in their entirety.

### BACKGROUND OF THE INVENTION

1. Field of the Invention

The present invention relates generally to the fields of quality assurance, compliance, and safety, of which the measurement and reporting of compliant and non-compliant behavior forms the basis thereof. The present invention is applicable to any industry or field in which behavioral compliance, or human and/or non-human spatial tracking is a key element, including, for example, the evaluation of quality and safety of a product (e.g., food production), or a service (e.g., elder or child care), or the recognition of or quality of an activity.

2. Description of the Related Art

The current practice of surveillance is typically performed through direct human observation at a particular location, or by indirect monitoring using a video monitor, by a human, at a remote location. Surveillance effectiveness is dependent on the attention of the people monitoring the system, and can be supplemented or replaced by the use of monitoring devices such as attachable/wearable radio frequency identification (RFID)-based technologies. Both approaches require expensive infrastructures, human interfaces to monitor the information feeds, require complete compliance (wearing RFID badges or bracelets), or may have privacy issues (i.e., video monitoring and recording of persons without their knowledge or consent). In addition, most video monitoring requires a human eye/brain to be constantly watching the feed, and in the case in which the video is not recorded or archived, it is often difficult or impossible to go back and search for something specific, retrospectively.

However, a surveillance system which does not require human monitoring, but which can provide a low cost, efficient, consistent, and reliable analysis of raw data (i.e., video, sound etc.), and which can analyze those data for compliance with predetermined standards or parameters, in real-time, with immediate feedback to users, is desired.

### SUMMARY OF THE INVENTION

The present invention relates to a method and apparatus of electronic surveillance, which continuously catalogs data (including video and audio) in an environment, allowing automated analysis of the data (in near real-time), in order to enable multiple analytical applications, as well as almost immediate feedback to users in the environment. The present invention may provide surveillance, analysis, and user feedback in instances in which it is more cost effective, or it is otherwise preferred, to have automated monitoring and analysis rather than a human observer.

The present invention utilizes networked or standalone data gathering devices that collect and relay raw data (e.g., images and sounds) to a processor, which interprets the data, recognizing specific activities, and provides real-time feedback to various users regarding compliance to and in some cases quality of, predetermined activities. The present invention employs a stand-alone data-gathering device, or may employ a plurality of data-gathering devices connected to a “mesh network” or its functional or similar equivalent. The data gathering devices are used to capture and relay data samples (i.e., images and sounds) to the processor of a stand-alone unit which is part of the data gathering device or a central processing system for a plurality of units, for analysis, and for storage in a database. In the centralized embodiment, the data gathering devices may be connected to one another, and are connected to a central processing system via an independent or adjunctive mesh network. The mesh network of the centralized embodiment of the present invention can function independently from a facility's own wired or wireless network, although it can interface with the network and utilize it for communication or other purposes when necessary. In one embodiment, stand-alone data-gathering devices may be connected to the facility's wired or wireless network, for communication, data analysis, or other purposes.

The data gathering devices sample incoming raw data (e.g., images and sounds) at predetermined intervals programmed by the user or based on feedback from the sensors, from different areas of the network based on the application (or combination of applications). The program then analyzes the data using multiple techniques including statistical analysis, signal processing and machine learning which represent a variety of approaches in which the program compares the data samples it has analyzed to obtain certain observations or inferences, to data samples stored in a data sample catalog in the database. The program, can analyze almost any type of incoming data (e.g., sound, face, object, movement, signals from badges), to determine what activities are taking place, and to generate feedback for users based on specific events/activities. The data samples are analyzed by the program in near real-time and results may include a number of basic observations such as status of room lighting, whether the door is open or closed, number of persons located within an observation area, if any, whether the persons are stationary or not, their activity, and the identity of those persons using biometrics (i.e., facial or voice recognition, etc.) or other technology, RFID badge identification, etc. The data samples are location-stamped, time-stamped, and date-stamped, and may be stored, either temporarily (for a predetermined period) or permanently, in the database. If a data sample is analyzed and identified by the program, and a close match or similar correlation is found in the data sample catalog, and that correlation or match has a feedback command associated with it in the feedback command catalog, then the program will issue a feedback command to one, all, or a specific combination of data feedback devices, and/or may inform users using electronic methods. The feedback devices, which are disposed with said data gathering devices, or may be separate devices, may or may not perform any processing, or relatively limited processing, and are designed to output a signal based on substantial identification and analysis of the signal occurring at the level of one or more processors of the system.

Cataloged observational data residing in the database of the system is available for querying and report generation by end users. Users interact with the data generated by the system through a user interface, disposed with said data gathering device and/or said feedback device, or separately therefrom, and connected to the processor and database. As stated above, the database may be at the local site (within or external to the system) or hosted in a cloud environment.

The present invention provides the capability to monitor and track various quality and safety measures in diverse environments, such as prisoner management, elder or children's care, and compliance in health care or in the food production or food service industry, etc., and provide immediate feedback to users. Thus, the present invention provides an efficient, consistent, and reliable method of measuring compliance and quality of compliance with predetermined standards or parameters.

In one embodiment, a method of conducting surveillance on activities being performed, includes: collecting data samples using at least one data gathering device and transmitting the data samples to a processor; analyzing the data samples using the processor; correlating each of the analyzed data samples or a combination of the analyzed data samples, using the processor, within a predetermined accuracy, with corresponding data samples in a data sample catalog stored in a database controlled by the processor; and issuing a feedback command using at least one feedback device, based on the correlation between the data samples and the corresponding data samples in said data sample catalog, on condition that the feedback command is associated with the correlation.

In one embodiment, the at least one feedback device is located proximate to, or combined with, the at least one data gathering device.

In one embodiment, the feedback command is proportionate to results of the correlation.

In one embodiment, the feedback command issues an audio alert or a visual alert.

In one embodiment, the processor performs in near real-time.

In one embodiment, the feedback command is repeated until the feedback command is turned off by the processor based upon predetermined instructions, or based upon instructions of a system administrator.

In one embodiment, the analyzed data samples are recorded continuously in the database, using the processor.

In one embodiment, the correlation of the analyzed data samples is recorded with the data samples in the data sample catalog in the database, using the processor.

In one embodiment, each issued feedback command is recorded in the database, using the processor.

In one embodiment, the data gathering device is part of a system which includes at least one of a camera, microphone, measurement device, sensor, motion detector, or scanner.

In one embodiment, the data samples include one of still frame, video, sound, speech, measurement data, motion, or scanned data.

In one embodiment, the camera facilitates visual identification based on biometrics, including at least one of visual, voice, motion, gait, movement, gestures, or physical characteristics.

In one embodiment, the individuals are not individually identified, but are categorized as a group.

In one embodiment, a temporary identity is assigned to an individual who is not identified after analysis of the data samples.

In one embodiment, a report is prepared using the processor, including information on the analyzed data samples and the issued feedback command.

In one embodiment, the report includes a trend analysis.

In one embodiment, all analyzed data samples are location, date-stamped and time-stamped by the processor for later retrieval and for inclusion in the report.

In one embodiment, predetermined personnel are notified by electronic means, of at least one of the correlation with data samples in the data sample catalog, or of the issuance of the feedback command.

In one embodiment, the data samples are discarded immediately or after a predetermined period of time.

In one embodiment, the processor is at least one of disposed in said data gathering device, or is disposed at a central processing system.

In one embodiment, the data gathering device is one of a plurality of data gathering devices which communicate with the central processing system over a network.

In one embodiment, the data gathering device is a stand-along device which includes a feedback command device.

In one embodiment, an apparatus which conducts surveillance on activities being performed, includes: at least one data gathering device which collects data samples and transmits the data samples to a processor disposed in the at least one data gathering device or at a central processing system; wherein the processor analyzes the data samples; wherein each of the analyzed data samples or a combination of the analyzed data samples, using the processor, are analyzed within a predetermined accuracy, with corresponding data samples in a data sample catalog stored in a database controlled by the processor; and at least one feedback device which issues a feedback command, based on a correlation between the data samples and the corresponding data samples in the data sample catalog, on condition that the feedback command is associated with the correlation.

In one embodiment, an apparatus which conducts surveillance on activities being performed, includes: at least one memory which contains at least one program which comprises the steps of: collecting data samples from at least one data gathering device and transmitting the data samples to a processor; analyzing the data samples using the processor; correlating each of the analyzed data samples or a combination of the analyzed data samples, using the processor, within a predetermined accuracy, with corresponding data samples in a data sample catalog stored in a database controlled by the processor; and issuing a feedback command using at least one feedback device, based on the correlation between the data samples and the corresponding data samples in said data sample catalog, on condition that the feedback command is associated with the correlation; and at least one processor which executes the program.

In one embodiment, a non-transitory computer-readable medium containing executable code for implementing a surveillance system which conducts surveillance on activities being performed, includes: collecting data samples from at least one data gathering device and transmitting the data samples to a processor; analyzing the data samples using the processor; correlating each of the analyzed data samples or a combination of the analyzed data samples, using the processor, within a predetermined accuracy, with corresponding data samples in a data sample catalog stored in a database controlled by the processor; and issuing a feedback command using at least one feedback device, based on the correlation between the data samples and the corresponding data samples in said data sample catalog, on condition that the feedback command is associated with the correlation.

Thus, there have been outlined some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1A is a schematic of the computer and network environment of a distributed surveillance system having one or more stand-alone data gathering devices, according to one embodiment consistent with the present invention.

FIG. 1B is a schematic of the computer and network environment of a centralized surveillance system, according to one embodiment consistent with the present invention.

FIG. 2 is a flowchart of singular features of the surveillance method, according to one embodiment consistent with the present invention.

FIG. 3A is a schematic of the apparatus of the stand-alone surveillance system, according to one embodiment consistent with the present invention.

FIG. 3B is a schematic of the apparatus of the centralized surveillance system, according to one embodiment consistent with the present invention.

### DESCRIPTION OF THE INVENTION

The present invention relates to a method and apparatus of electronic surveillance, which continuously catalogs data (e.g., video and audio) in an environment, allowing automated analysis of the data in order to enable multiple analytical applications, as well as immediate feedback to users in the environment. The present invention may provide surveillance, analysis, and user feedback in instances in which it is more cost effective, more efficacious, less intrusive, or, it is otherwise preferred, to have automated monitoring and analysis rather than a human observer.

In one embodiment, the present invention generally includes the following components, either disposed in one or more structures, or separately: 1) a plurality of data gathering devices; 2) a plurality of feedback devices; and 3) a central data processing system (a computer with program) and a graphical user interface (GUI).

General Description of the System

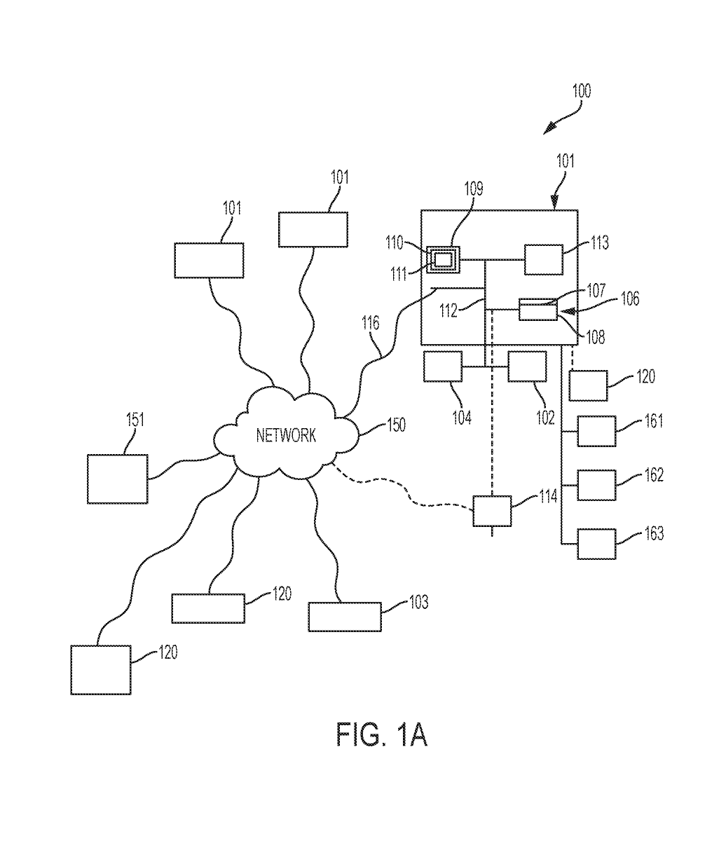

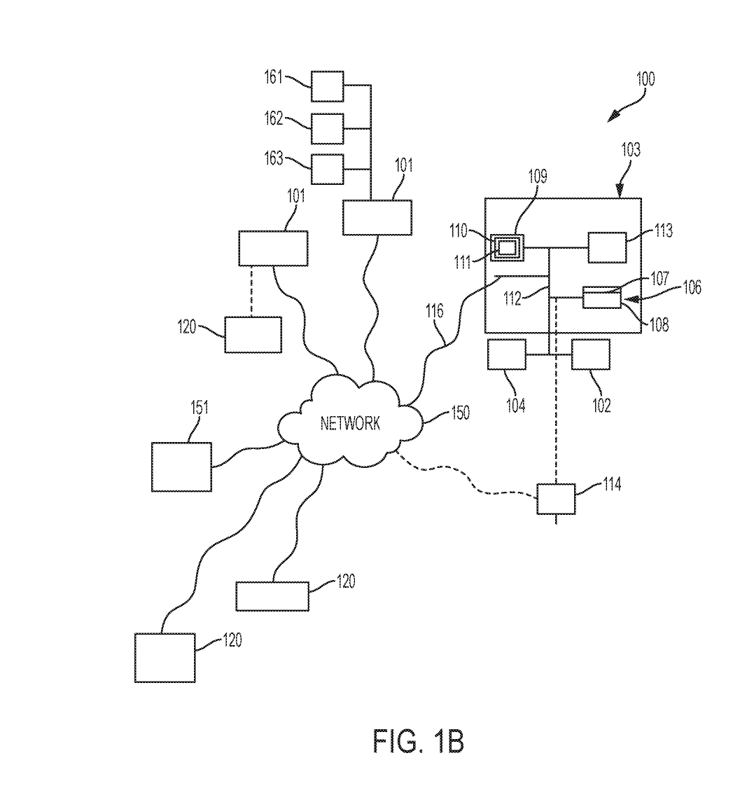

As illustrated in FIGS. 1A-1B, electronic surveillance applications may be implemented using the system 100 according to one embodiment of the present invention. The system 100 includes a plurality of data gathering devices 101, which are designed to interface over a network 150. In one embodiment as shown in FIG. 1 A, the data gathering devices 101 are stand-alone and function independently from one another, and may access external storage or other devices or systems over the internet 150.

In another, centralized embodiment as shown in FIG. 1B, the data gathering devices 101 are in bi-directional communication with a central processing system 103 over the network 150, from/to which information can be provided or retrieved to/from other devices (i.e., data gathering devices 101, feedback devices 120, external storage devices 114, GUIs, etc.). According to one embodiment, bi-directional communication between the system 100 of the present invention and the data gathering devices 101 allows the system 100 to update information that is stored at the central processing system 103, or external storage 114. According to one embodiment of the invention, bi-directional communication between the system 100 of the present invention and the data gathering systems 101 allows the system 100 to generate desired reports and/or other information.

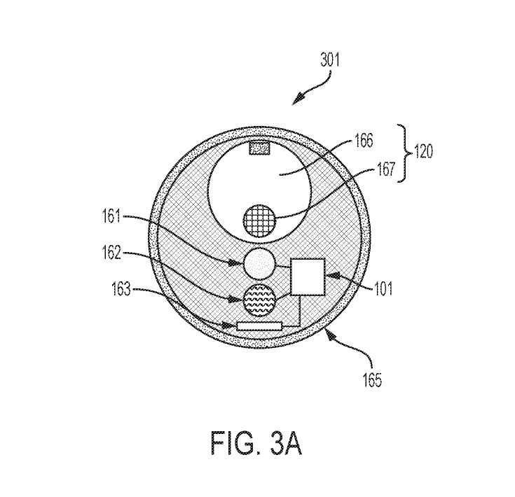

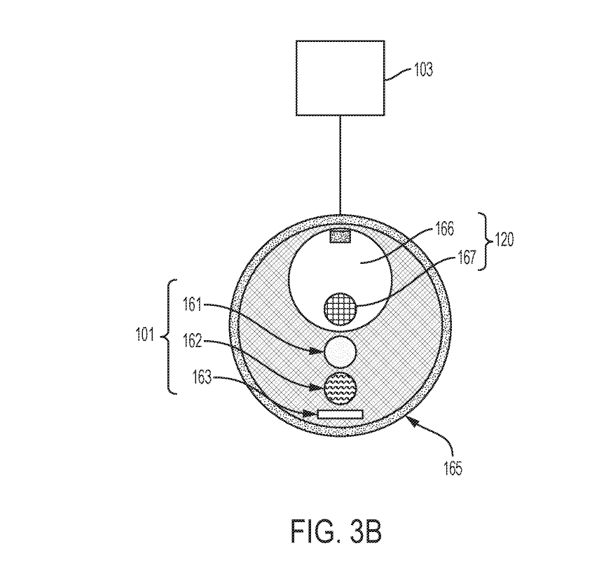

More specifically, as shown in FIG. 1A, the system 100 of the present invention includes a stand-alone device 301 (see FIG. 3A), which includes a data gathering device 101. The data-gathering devices 101 each contain at least one individual processor 106 within a housing 165. In this embodiment, the processor 106 that provides data processing, and may include a central processing unit (CPU) 107, a parallel processor, an input/output (I/O) interface 108, a memory 109 with a program 110 having a data structure 111, and/or other components. According to one embodiment of the invention, the components all may be connected by a bus 112. Further, the device 101/301 may include one or more secondary storage devices 113. According to one embodiment of the invention, the bus 112 may be internal to the device 101 and may include an adapter that enables interfacing with a keyboard or other input device 104. Alternatively, the bus 112 may be located external to the device 101/301.

In one embodiment, the system 100 includes an image display device 102, and one or more external storage devices 114.

According to the centralized embodiment of the invention as shown in FIG. 1B, the data gathering devices 101 have less capability than the stand-alone embodiment, and may forward data to a hub or central processing system 103 over a network 150.

In one embodiment, the stand-alone data gathering device 101/301 (see FIG. 3A), may also be connected to a central processing system 103 (see FIG. 1B) over a network 150 for some processing operations, storage of data, or networking to other devices or databases.

In one embodiment, the central processing system 103 of the present invention may be a personal computer (PC) (see FIGS. 1A and 1B).

In one embodiment, the central processing system 103 may include a processor 106 that provides data processing, and other components similar to that of the stand-alone device 301. In one embodiment, as noted above, the processor 106 may include a central processing unit (CPU) 107, a parallel processor, an input/output (I/O) interface 108, a memory 109 with a program 110 having a data structure 111, one or more secondary storage devices 113, and/or other components. In one embodiment, the components all may be connected by a bus 112. According to one embodiment of the invention, the bus 112 may be internal to the central processing system 103, and may include an adapter that enables interfacing with a keyboard or other input device 104. Alternatively, the bus 112 may be located external to the data processing system 103.

Further, the data processing system 103 may include the input device 104, the image display device 102, and one or more external storage devices 114.

As noted above, both the stand-alone or centralized embodiments of the present invention (see FIGS. 1A and 1B), may include an imaging display device 102, such as a real-time dashboard display 102, which is capable of providing high resolution digital images in 2-D or 3-D, for example. According to one embodiment of the invention, the data processing system 103 may be a mobile terminal if the image resolution is sufficiently high. Mobile terminals may include mobile computing devices, a mobile data organizer (PDA), tablet, smart phone, or other mobile terminals that are operated by the user accessing the program 110 remotely.

According to one embodiment of the invention, an input device 104 or other selection device, may be provided to select hot clickable icons, selection buttons, and/or other selectors that may be displayed in a user interface using a menu, a dialog box, a roll-down window, or other user interface. The user interface may be displayed on the dashboard display 102 of the central processing system 103. According to one embodiment of the invention, users may input commands to a graphical user interface through a programmable stylus, keyboard, mouse, speech processing device, laser pointer, touch screen, or other input device 104.

According to one embodiment of the invention, the image display device 102 may be a high resolution touch screen computer monitor. According to one embodiment of the invention, the image display device 102 may clearly, easily and accurately display a variety of images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment, the invention may be implemented by an application that resides on the stand-alone system 301, or on the central processing system 103, wherein the application may be written to run on existing computer operating systems. Users may interact with the application through a graphical user interface. The application may be ported to other personal computers (PCs), personal digital assistants (PDAs), cell phones, and/or any other digital device that includes a graphical user interface and appropriate storage capability.

According to one embodiment of the invention, the processor 106 may be internal or external to the data gathering device 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the system 100 or external thereto. While the system 100 of the present invention may be described as performing certain functions, one of ordinary skill in the art will readily understand that the program 110 may perform the function rather than the entity of the system 100 itself.

According to one embodiment of the invention, the program 110 that runs the system 100 may include separate programs having code that performs desired operations. According to one embodiment of the invention, the program 110 that runs the system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations.

According to one embodiment of the invention, the data structure 111 may include a plurality of entries. According to one embodiment of the invention, each entry may include at least a first storage area, or header, that stores the databases or libraries of the image files, for example.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the data processing system 103, either directly or indirectly through a communication network, such as a LAN, WAN, and/or other networks. The data storage device 113 may be an internal storage device. According to one embodiment of the invention, the system 100 may include an external storage device 114. According to one embodiment of the invention, data may be received via a network 150 and directly processed.

According to one embodiment of the invention, the data gathering devices 101 may be coupled central processing systems 103 or servers, or other data gathering devices 101, other auxiliary systems, such as public address (PA) systems, etc., as well as feedback devices 120, whether over the network 150 or directly (see FIGS. 1A and 1B).

The feedback devices 120 execute auditory and visual feedback commands when issued by the stand-alone device 301 or the central processing system 103 of the centralized embodiment 100. The feedback devices 120 may be disposed in the same housing as the data gathering device 101 (see FIGS. 3A-3B), or may be separately provided (see FIGS. 1A-1B). Feedback may be in the form of voice, audio, music audio or some other tone or sound, and/or visual text or light display, or some other graphical display capable of being generated from the feedback devices 120 (i.e., visual displays and lights 166, or microphones, speakers 167 etc.). In one embodiment, the feedback devices 120 may have relatively limited functionality to optimize energy efficiency.

The feedback devices 120, as well as the data gathering devices 101 may run on battery power, or may be plugged into other devices from which they draw power, or standard AC power.

According to one embodiment of the invention, the stand-alone devices 301 or centralized data processing system 103 of the centralized embodiment, may also access administration systems, billing systems and/or other systems, over the network 150, via a communication link 116.

According to one embodiment of the invention, the communication link 116 may include a wired and/or wireless communication link, a switched circuit communication link, or may include a network such as a LAN, WAN, the Internet, or combinations thereof. According to one embodiment of the invention, the communication link 116 may couple e-mail systems, fax systems, telephone systems, wireless communications systems such as pagers and cell phones, wireless PDA's and other communication systems.

According to one embodiment of the invention, the communication link 116 may be an adapter unit that is capable of executing various communication protocols in order to establish and maintain communication with external devices 151, data gathering devices 101, a central processing system 103, and if separately provided from the data gathering devices 101, feedback devices 120 as well. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

In one embodiment, as noted above, the stand-alone system 101 includes a plurality of individual processors 106 disposed in one or more data gathering systems 101. Thus, the present invention may be implemented using software applications that reside in a stand-alone system over a computerized network 150 and across a number of computer systems 100, or at a centralized processing system 103. In one embodiment, the present invention may be implemented using software applications that reside in a client and/or server environment. Thus, in the present invention, a particular operation may be performed at a stand-alone system 301, the central processing system 103, or at another system, or a plurality of systems.

According to one embodiment of the invention, as noted above, the system 100 is coupled to a network 150, such as a Local Area Network (LAN), Wide Area Network (WAN), Wi-Fi network, Bluetooth network, and/or the Internet, etc., over a communication link 116. Further, in a centralized embodiment, even though the data gathering systems 101 and external systems 151 may be directly coupled to the central data processing system 103, these systems may be indirectly coupled to the central data processing system 103 over a LAN, WAN, Wi-Fi, Bluetooth, Internet, and/or other networks via one or more communication links 116. According to one embodiment of the invention, users may access the various information sources through secure and/or non-secure Internet connectivity. Thus, operations consistent with the present invention may be carried out at the central data processing system 103 or elsewhere, such as at each stand-alone data gathering device 301.

According to one embodiment, user interfaces may be provided that support several interfaces including display screens, voice recognition systems, speakers, microphones, input buttons, and/or other interfaces. According to one embodiment of the invention, select functions may be implemented through the central data processing system 103, or at each data gathering device 101, by positioning the input device 104 over selected icons. According to another embodiment of the invention, select functions may be implemented through the data gathering device 101 or at the central data processing system 103 using a voice recognition system to enable hands-free operation. One of ordinary skill in the art will recognize that other user interfaces may be provided.

Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more data processing systems may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, USB drives, or other forms of ROM or RAM either currently known or later developed. Further, although specific components of the system have been described, one skilled in the art will appreciate that the system suitable for use with the methods and systems of the present invention may contain additional or different components.

Detailed Description of the System

The following detailed description of the system 100 of the present invention includes the operation of the stand-alone and the centralized embodiments, among others, of the present invention. Any departures from the general operation of the present invention are described in detail with respect to each particular embodiment.

According to one embodiment, as illustrated in FIGS. 1A and 1B, the data gathering devices 101 gather data, and may be of any suitable size, but may also be miniaturized devices (for example, 3 inches or less in width or length). In the stand-alone embodiment, the data gathering devices 101 may include one or more of a wireless mini-camera 161, a microphone 162, or a sensor or reader 163, such as a photo-electric sensor, an RFID scanner, or gas sensor, etc. (see FIG. 3A). However, in this and the centralized embodiment, the items may be separately disposed.

In the centralized embodiment of the present invention, the data-gathering devices 101 are designed to have minimal functionality to optimize energy efficiency. However, in a stand-alone embodiment, the data gathering devices 101 are designed to have maximum capability. However, the data gathering devices 101 may have capability anywhere between minimum functionality and maximum capability.

In one embodiment, the data gathering devices 101 may be low-powered and able to operate independently via photovoltaic and/or battery power (or a combination of these), or they may be powered by standard AC power. Depending on whether the data gathering devices 101 are stand-alone or centralized, the devices 101 may have substantial identification and analysis of the signals collected, occurring at the level of one or more of the stand-alone 301 or central processing units 103. The data gathering devices 101 may communicate with other similar devices 101 and may communicate with a central processing system 103 via a network 150, without requiring human intervention. The data gathering devices may operate within in a variety of lighting conditions, including, if desired, those conditions that require infrared capability, and can generate and utilize images with infrared lighting rather than “natural” lighting.

According to one embodiment of the invention, the data-gathering devices 101 continuously collect raw data, which include a combination of images, sounds, and motion capture, etc. The inputs (i.e., camera 161, microphones 162, sensors 163 etc.) of the data gathering devices 101 collect data and transmit the data to the processor 106 via a communication link 116 over a network 150.

In a centralized embodiment, the method of transmission may be via a “mesh” equivalent network (see FIG. 1B) which exists independently of the networking infrastructure of a facility, such as a home, hospital, industrial facility, prison, etc. In other embodiments, the system 100 of the present invention may utilize a wired or wireless network 150 (see FIGS. 1A and 1B), shared with outside infrastructure or independent of any other network.

In one embodiment, the data gathering devices 101 may transmit data at predetermined intervals, such as at approximately one image, sound, or motion, per second, to the processor 106 for analysis.

In one embodiment, the data gathering or monitoring devices 101 may be set or programmed, to acquire and send captured video, image, motion, and audio, etc., at rates of sampling and resolution that are determined based on the observations/activities analyzed by the processor 106, to increase efficiency. In one example, the data gathering device 101 could be set to perform at a relatively low resolution image at a relatively long sampling rate when a room is empty at night, and have that resolution and sound sampling rate increase when the room becomes occupied. Another example would be to implement a modification of the sampling rate of image acquisition when a person is moving, or of sound acquisition when they are speaking. There are an unlimited number of ways that the program 110 of the processor 106 could direct the data processing devices 101 to modify their sampling rate or resolution (quality of the image or sound sample) based on observations or activities, to effectively respond to the incoming image and sound data.

In one embodiment, the processor 106 receives the data from the data gathering devices 101, and the program 110 performs an analysis of that data sample to make basic observations such as identification of persons, state of the environment, etc. In one embodiment, the data recognition function is conducted by searching the data sample catalog of the database 113 or 114 for a “match” (or close match—which can be programmed to be within a certain percentage of accuracy) between each incoming image, sound, or motion data sample, with a data sample in the data sample catalog. This correlation or matching can be facilitated by a variety of signal processing, machine learning, and statistical analytic techniques, on the data sample.

In one embodiment, the data samples are analyzed in order for the program 110 to make observations or inferences as to what is occurring under the surveillance. For example, the program 110 could make inferences from a series of analyzed data samples in order to infer what changes are occurring, such as whether persons are in the room, their identities, or their activities etc. For example, the program 110 will have the capability to make a data sample (close) match or “recognize” an individual either “biometrically”, such as by facial, skeletal, gait, muscle/force uniqueness, fingerprint, or optical characteristics, or by activity or movement, or alternatively by badge-based recognition via RFID, barcode, or other type of device-based smart-scan such as Bluetooth or other smart phone-like technology.

In one embodiment, when the program 110 has analyzed the data sample and fails to find a correlation or likely close match in the data sample catalog of the database 113, the program 110 creates a notation in the database 113 that a data sample was received and analyzed, but that the analyzed data sample was not recognized as one from the data sample catalog. In another embodiment, any analyzed data sample that is not correlated with one in the catalog may be discarded by the program 110 without a notation in the database 113. In these cases, an alert may be automatically forwarded by the program 110 to the system administrator or user, so that the matter may be investigated further, if desired. The alert may be sent by electronic means or methods, such as via text, email, facsimile, etc.

In one embodiment, a list of data samples (including observations and inferences, etc.) is previously stored in the data sample catalog of the database 113 or 114, based on the needs for that particular application, such as activity tracking, population management, etc. The data sample catalog is accessed in advance of any application of the present invention, by an administrator who uploads the data samples into the data sample catalog with corresponding observations/matches that the program 110 is programmed to recognize and catalog. The data samples are web accessible within a larger catalog of available data samples. The same website allows an administrator to create customized data samples. In one embodiment, data samples can be deleted or added to the data sample catalog by administrators, based on the evolving needs of the application.

In one embodiment, if the program 110 correlates the analyzed data sample with one in the data sample catalog, then the analyzed data sample is identified by location (of the data gathering device 101), time and date-stamped, and stored by the program 110 in the database 113 on a temporary (predetermined period of time) or permanent basis.

In one embodiment, the program 110 then searches for a correlation of that analyzed data sample with an associated feedback command, in the feedback command catalog (already preprogrammed) of the database 113. When an identified/analyzed data sample is matched with a feedback command, the program 110 issues a feedback command to one, all, or a specific combination of the feedback devices 120.

Prior to implementation of any application, the administrator would access the feedback command catalog in order to upload the list of feedback commands the program 110 will execute based on the observations made from the recognized data samples via the data sample catalog. In this embodiment, the feedback commands are web accessible within a larger catalog of available feedback commands. The same website allows an administrator to create feedback commands in addition to those that are programmed as default. The customized feedback commands may include customized audio responses.

In one embodiment, the feedback devices 120 (see FIGS. 3A and 3B) are devices designed to execute one or a combination of auditory and visual commands, or electronic commands, when issued by the program 110. The devices 120 communicate with one another and with the processor 106 directly, either internally, or over a mesh network, or other network 150 or connectivity (i.e., Wi-Fi, etc.). The devices 120 may vary in size, and may be audio only, visual only (i.e., light display), audio and visual, with various controls, such as brightness and/or volume controls, and would be either operating independently via photovoltaic and/or battery power, or by AC power, without human intervention for a long period of time. They may also utilize a simple motion sensing/detector technology, with substantial identification and analysis of the signal(s) collected occurring at the level of one or more processors 106.

In one embodiment, feedback commands from the program 110 to the feedback devices 120 may result in the form of voice, audio (i.e., music or some other tone or sound), and/or visual, visual text, or light display, badge, or some other graphical display (i.e., emoticon, symbol), or electronic communication (i.e. text, email, facsimile etc.). Like the data gathering devices 101, the feedback devices 120 are designed to have a range of functionality, or minimal functionality to optimize energy efficiency.

In one embodiment, a single or selected group of feedback devices 120 are automatically selected by the program 110 for feedback commands based on the instructions in the feedback command catalog. In another embodiment, all data feedback device(s) 120 would receive the command by the program 110, and execute every such feedback command.

In one embodiment, the user is notified by electronic means (i.e., text, email etc.), and then implements the type and number of feedback devices 120 to be utilized. In yet another embodiment, the data is only gathered by the data gathering devices 101, stored in the database 113, and no feedback commands are listed in the feedback command catalog of the database 113, or issued by the program 110, leaving room for human intervention as desired.

In one embodiment, data is continuously collected by the data gathering devices 101, identified by the program 110, and archived in the database 113 and/or 114, while simultaneously, feedback commands are identified and transmitted by the program 110, and executed by the feedback devices 120. In one embodiment, the data samples, archived analyzed data samples, and issued feedback commands are accessed at “as-needed” intervals, via a query from a user at the data gathering device 101, or at the central processing system 103, or from an external device 151 (i.e., tablet, etc.) over a network. The administrators of the system 100 would set the access rights for each stakeholder with respect to what type of reports they may receive, if any. The users may query the database 113 for information on any of the analyzed data samples and executed feedback commands, to answer questions or create reports. Alternatively, the program 110 may compile reports automatically at predetermined intervals, for delivery to the user by electronic means (i.e., email, text, etc.). In one embodiment, identified data samples and feedback commands archived in the database 113, are displayed by the program 110 in real-time on the display 102. Thus, the present invention provides a real time status of observations and feedback, as well as a mechanism to archive and query all of the data collected and acted upon over time.

Exemplary Applications

The following include a number of exemplary applications for which the present invention may be used. The various applications may overlap in operational features. However, one of ordinary skill in the art would know that any application that could utilize the features of the present invention would be suitable.

Hand Hygiene Compliance System:

Hospital Acquired Infections (HAI) impose an enormous financial burden on the global healthcare system and represent a serious medical threat to patients. Each year, it is estimated that 1 in 20 patients admitted to a hospital in the United States (U.S.) acquire one or more infections while in the hospital and approximately 100,000 patients die from related complications. The total cost of care for HAI in the U.S. alone is estimated to be $10 to $30 billion annually. The most frequently occurring cause of HAI is poor hand hygiene. While this may seem like a simple issue to resolve, for many reasons there has been little improvement in hand hygiene in healthcare facilities despite significant investment in awareness campaigns by organizations such as the World Health Organization and the U.S. Center for Disease Control.

Treating HAI is a cost to the system, but it is currently also a source of revenue to the hospital that treats the infection. Under the Affordable Care Act (ACA), Medicare can refuse reimbursement of these costs and penalize institutions that do not measure and take steps to reduce the incidence of these infections. Hospitals have implemented strict protocols mandating hand sanitization before and after patient contact, but compliance with these protocols are mixed resulting in the continued occurrence of these infections.

In one embodiment of the present invention, the system 100 of the present invention would utilize data gathering devices 101 and feedback devices 120 in the vicinity of hand hygiene stations and patient care areas. Handwashing compliance monitoring would determine the number of times handwashing was performed by specifically identified individuals or non-identified individuals or categories of individuals or at particular stations, departments or areas, or the quality of the handwashing itself, including the duration of the handwashing, the amount of soap used and whether it is used, the direction of flow of water from arm to hand to fingertips, and coverage of both sides of the hands, for example. Through the data gathering devices 101, the system 100 would forward data to the central processing system 103, where the program 110 would analyze the data, check the resulting analyzed data samples against the data sample catalog for observations/inferences, and check the results of this analysis against the feedback command catalog, in order to recognize compliance or non-compliance with the hand washing protocol. In this application, the program 110 will trigger the feedback device 120 to acknowledge compliance, or in the case of non-compliance, to issue a feedback command to a feedback device 102 to remind the person to comply with the hand-washing protocol (i.e., turn on a flashing red light or play a tune or display an image or movie).

The system 100 of the present invention could also collect hand washing compliance data by hospital unit (e.g., intensive care, cardiac, dialysis, etc.), and as noted above, by the individual (with facial recognition technology, where the analyzed data samples are compared against a database of previously programmed authorized individuals), enabling the hospital to take specific, documented, individual action, to improve compliance with hand washing protocols, thus, enabling the hospital to participate positively in the incentives provided by the ACA.

Of course, hand washing compliance in the food industry (i.e., restaurants, food handling, etc.) would be another important area where the present invention could be used.

Individual Follow-Up Management:

One of the most common reasons for patients presenting to an emergency room and/or for hospital readmission is failure to follow up with an outpatient appointment. This is especially true for patients who have been recently hospitalized.

The data gathering devices 101 would record patient activity in the reception/waiting area of each follow-up hospital, medical office, or other healthcare facility. The program 110 would analyze the data collected and compare the resulting data samples (including facial recognition data to determine individual appointment attendance), to the appointment data stored in the healthcare facility's records (i.e., data sample catalog), to determine patient compliance with follow-up appointments. If the program 110 does not match a data sample of the patient with a patient appointment in the patient database, then the program 110 will trigger an instant follow-up with the patient using electronic means (i.e., text message, email, etc.). The program 110 may also alert the facility or healthcare provider by similar electronic means, to inform them that the patient is in non-compliance so that they may follow-up with the patient personally.

As non-attendance for follow-up appointments is a frequent cause of re-admission to a hospital, the attendance information would be of great value to the hospital as proof that the re-admissions are not the fault of the hospital and thus, eliminate the risk of non-reimbursement to the hospital. This would also be a great value to public and private payers as they save hospitalization costs while providing enhanced case management services to their members.

This application could also be used in other industries/settings where individualized monitoring and follow-up are critical, such as in law enforcement, where individuals on probation or parole, are required to meet with probation or parole officers, respectively.

Surgery Turnover Management:

Surgical suites are the highest cost and highest revenue generating units in most hospital and surgical settings. Inefficient use of the surgical suite directly impacts the hospital's bottom line. The data gathering devices 101 could be installed to record activity in the surgical suite. For example, when the program 110 determines that a suite is vacated by a change in the observations/inferences of the data samples, the feedback command function could trigger an alert to an administrator, via electronic means (i.e., email, etc.), which would allow for the fastest possible turnaround of the surgical suites to enable re-use of same. The program 110 could also determine when bottlenecks or delays in surgical procedures are occurring, which information could subsequently be used by hospital administrators to reduce the surgical time and maximize the efficiency of surgical suite utilization.

Prison Population Management:

The system 100 of the present invention could be utilized to create a real-time mapping dashboard on a display 102 of every single person, including prisoners, staff, and visitors, at any given time in the facility. The program 110 would utilize facial recognition or biometric software to identify persons by facial characteristics, by gait, or other biometric data, and graphically display each person in the facility, their movement and location, at any given time. The program 110 could distinguish between types of individuals (i.e., guards vs. prisoners, using imaging recognition, or R.F.I.D. badge recognition, etc.), and be programmed to issue feedback commands such as alerting staff by visual, audio, or electronic means, if there are any unusual behavior patterns (i.e., a large group of prisoners congregating in a certain area). For example, if the analyzed data sample indicates a door is unlocked (either visually, or by an interrupt in an electronic transmission (i.e., broken electrical circuit)), and the match in the data sample catalog indicates that this is high risk issue in a prison environment, then the program 110 will issue a feedback command to a feedback device (i.e., siren to be activated), or an electronic alert to a user (i.e., text message)).

Among other things, the program 110 could be used to provide prisoner cell check and verification of identity throughout the prison facility, or send an instant alert (i.e., audio, visual, electronic means, etc.) if a prisoner or a visitor enters an unauthorized area, or if anyone has entered the prison without being properly identified. The program 110 could also be used to evaluate for unusual aggregation of prisoners in a particular area in a different pattern than normal or other suspicious or potentially dangerous behavior.

A similar application would be monitoring in an assisted care facility for patient wandering or elopement or to document assisted living patient activities during the course of the day including taking medications, assessing patient fall risk, patient waking at night, and assessment of patient safety in general.

Industrial Espionage/Secure Facility Protection System:

The program 110 could be utilized to alert security personal immediately, via visual, audio, or electronic means, if an unauthorized person enters a secure facility or sensitive area, or to alert administrators if any person has entered a sensitive area for recordkeeping reasons. The facilities could include plants, power facilities, dams, airports, governmental facilities, military bases, etc. Identification of the persons would be determined by the program 110 and records of the data samples and feedback commands may be stored in the database 113. The program 110 could provide real time mapping of the firm's entire facility, to locate persons and even certain equipment if tagged for monitoring. The monitoring of persons could also be extended to time and attendance for employees, break-times, compliance with safety programs, etc. All data can be stored by the program 110 in the database 113 such that historical data could be easily queried.

School System Monitoring:

Similarly to a secure facility monitoring, schools may benefit from the present invention, to not only monitor pupil attendance, perform hall monitoring for unauthorized personnel or unusual or dangerous activity (i.e., school shooter, where persons are detected by the program 110 as running in the halls or congregating in locked rooms), room monitoring, teacher location monitoring, unknown visitor surveillance, and safety monitoring.

Facility Population Monitoring:

Again, similar to secure facility or school system monitoring, etc., nursing home patients can be monitored in a similar manner, including the activity of the patients, visitors, nurse visits, staff attendance, etc. Hospitals could monitor persons with access to drugs to control theft, monitor attendance, etc. Parents can monitor children at home for sneaking out, inappropriate visitors into bedrooms, baby-sitter performance, family members with neurological deficits such as dementia, Alzheimer's, etc. who wander away from home, and to monitor workmen in the home for inappropriate access to private rooms, etc. Public facilities such as train stations, bus stations, parks, etc., could be monitored for the movement of people, employee attendance, security, etc., as noted above. Of course, the present invention can be used as a security system for robbery or burglary, or supplement an existing security system at any facility.

Public Facility Monitoring:

In other applications, the present invention could be used in restaurants for hand-washing compliance (as noted above), for time and attendance, break-times, efficiency, and other quality and safety practices.

In other public facility applications, the present invention may be used in retail store monitoring of customer activities, shoplifting surveillance, monitoring customer activity, tracking patterns of shopping, monitoring store employee attendance and activity, identification of shortest lines in the store adjusted for amount of material in the shopping cart and providing notice to customers of shortest predicted lines, etc., which are all important areas where the present invention can be used to advantage.

In addition, stadiums, concert halls, or other public facility monitoring, are other venues which would benefit from the present invention, to determine attendee movements for safety and security, as well as determining which lines at food stands are longest, as well as lines for bathrooms, etc.

Law Enforcement Applications:

In addition to parole and probation monitoring above, the present invention could be used in monitoring street crime, to determine suspicious behavior on streets, in neighborhoods, as well as to perform traffic monitoring, and to contribute to a neighborhood watch in monitoring for unusual activity.

Additional Applications:

As one of ordinary skill in the art would know, there are a myriad of other additional applications in a variety of different fields, with which the present invention could contribute to the safety and efficiency of operations management. For example, keeping track of pets at home, or children at home or playing in the yard, etc.

The following provides a couple of detailed examples which can be used to provide more specifics regarding how the present invention is implemented.

### Example 1

In one example of a facility monitoring operation, the present invention may be implemented in a school system. In one embodiment, the data monitoring devices 101 would be located in the particular rooms that the administrators would wish to monitor (i.e., classrooms, athletic facilities, administrative offices, records rooms, cafeteria, kitchen, playing fields, etc.). The data gathering or data monitoring devices 101 could include, among a number of devices, cameras 161 located at positions conducive to individual facial recognition (i.e., trained on doorways to capture images of persons entering/leaving), or crowd monitoring (i.e., in hallways, cafeterias, or trained on players in athletic facilities or fields, or on spectators), etc. The data monitoring devices 101 could also include microphones 162 to detect voices for voice recognition, or to detect noise decibels over a certain threshold (i.e., detect screaming, shots fired), or any noises at all (i.e., noises heard in the school after closing), etc. Other data monitoring devices 101 could include sensors/readers 163 (see FIGS. 3A-3B) which detect gas leaks, or bar code or magnetic readers etc., which detect the identification or badges of teachers or school personnel, or student I.D.s or badges.

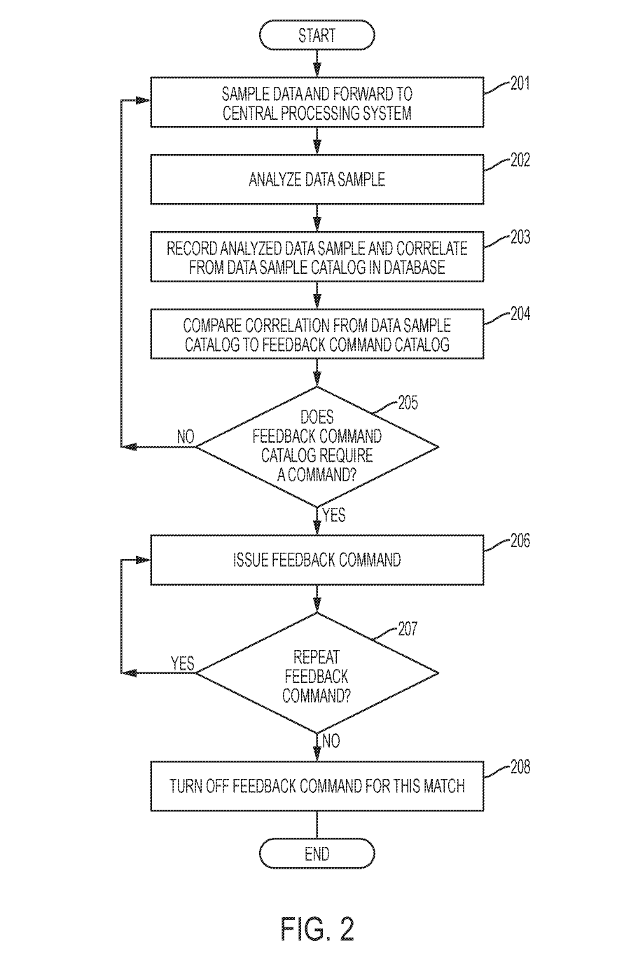

In step 201 (see FIG. 2), the data monitoring devices 101 would continuously sample data and forward the data every predetermined period of time (i.e., every second) to the processor 106 for analysis.

In step 202, the processor 106 would receive the data, including but not limited to still frame, video, sound/speech, measurement data, etc. from the data monitoring devices 101, and the program 110 will analyze the data, to correlate the analyzed data sample with a data sample in the data sample catalog. This correlation or match could provide information such as, for example: 1) the identification and number of individuals in a room, 2) the room characteristics such as lighting, whether the doors are open or shut, 3) the movement of persons in/out of the room, 4) the time of day, 5) whether the noise level is above a certain decibel, 6) whether identified or unidentified persons are noted entering the room/facility, 7) whether identified or unidentified persons are walking through the facility (i.e., the hallways during class time), 8) the speed of movement of persons in the facility, 9) crowd gathering in any part of the school, 10) the actions of persons within a room (i.e., whether lying, sitting, or standing), 11) the data from measurement devices (i.e., whether gas measurement devices 163 indicate a leak), and 12) any other changes in the environment that the administrators want to take note of, and which can be programmed to be analyzed by the program 110.

The program 110 can identify each person according to facial, gait, and/or voice recognition, etc., with a high level of interpretation accuracy, in addition to, or instead of reading their student I.D., for example. Further, each observation or analyzed data sample by the program 110 is compared with records in the data sample catalog of the database 113, of images, sound samples, catalog of individuals, etc., in order to determine with a high degree of confidence, that each observation/behavior identification (data sample) is correctly interpreted.

In some instances, specific movements (i.e., washing hands in the kitchen, brushing of teeth, eating, drinking, talking on the phone, gait/walking, crying, etc.) or a specific sequence or combination of movements, can be interpreted by the program 110. In some facilities, such as hospitals, taking pills, falling, asking for help, having visitors or visits by medical personnel, etc., can all be monitored, and the data stored and analyzed by the program 110.

In one embodiment, for unidentified persons, the program 110 can assign a “temporary” identity to each such individual (stored in the database 113 with image) in order to track them separately, despite not knowing the actual identity of the person(s).

Thus, the program 110 has the ability to discriminate data in defined ways, and can do so without counting the number of people (i.e., monitoring a group or crowd without determining the exact number), and without counting the same person twice (regardless of whether it has the ability to determine the actual identify of the person), in order to determine the specific behaviors taking place for each person(s).

In step 203, the program 110 may record the data in a continuous log in the database 113, or 114, as raw data (i.e., video, images, sounds, etc.), or may discard same after analysis. However, the program 110 will record the matching of the analyzed data samples, and the results of that match or analysis with the data sample catalog, in the database 113, 114. This allows the program 110 to create a continuous stream of analyses/activities without necessarily recording/storing the raw images or sounds, etc., to maintain privacy at the facility, workplace, home, etc.

Thus, the program 110 matches the analyzed data samples with those in the data sample catalog, and that analysis provides inferences such as whether there is a room without a teacher and/or whether the students are becoming unruly, or whether an unidentified person has entered the school and roaming the hallways, or whether a student or intruder has fired shots in the facility, or whether an incident has occurred to make persons run through the hallways, or whether there is a security issue as a crowd has formed in one part of a room or within the school, etc.

In step 204, once the program 110 has made the inferences (analysis) from the data sample correlation with the data sample catalog, then the program 110 will compare the inferences/analysis to the feedback command catalog, to determine if a feedback command is to be issued. The processing capability of the central processing system 103 is such that the program 110 can issue a rapid response to the feedback devices 120 as incoming data is interpreted.

In step 205, if a feedback command is determined to be issued, then the program 110 will send the command out, in step 206, to the feedback devices 120, which may be located within the same housing as the data gathering device 101 (see FIGS. 3A and 3B), or separately, proximate or remote to the data gathering devices 101, or send out electronic commands over Wi-Fi, the Internet, or cellular networks. The feedback command is programmed by administrators to be appropriate to the analysis of the event that is occurring. For example, the feedback command may be to issue a siren 167 when a measurement device or visual analysis by the program 110 (analyzed data sample) determines from a correlation in the data sample catalog, that there is smoke in a room; or to send a pre-programmed voice message to students to clear the halls after the class bell has rung (and students are still congregated in the halls); or to send an alert (via electronic means such as email, facsimile, text, etc.) to security personnel or the police, if shots are determined to be fired at the school. Thus, any number of feedback commands can be implemented based on the program's 110 identification of the analyzed data sample, its correlation and corresponding feedback command in the feedback command catalog, and this can be done in real-time and rapidly, which can enhance the safety and security of the individuals at the facility.

If in step 205 there is no feedback command associated with that data sample match, then the program 110 will simply continue its sampling of raw data at the data gathering devices 101.

If in step 207, the feedback command is desired to repeated, then the program 110 will continue repeating the command (i.e., keep a siren blaring) at step 206, until turned off in step 208, based upon the program's 110 prior instructions, or as directed by the administrators. If the feedback command is desired to be turned off in step 208 after a command (i.e., an email) is sent at step 207, regardless of the number of matches to the feedback command catalog, the program 110 will not issue another command (i.e., another email).

The program 110 can respond to a query for data captured and commands issued, by providing same, including an analysis of specifics with respect to a particular incident. The program 110 can also provide trend analysis over a number of incidents and/or reports, or produce a report upon request or at predetermined intervals. The report may be accessed via a customizable user interface on the administrator's electronic device (i.e., computer, tablet, phone, etc.). The user interface would also allow the user to query in real-time, data being transmitted from the data gathering devices 101 in any combination of available data parameters (i.e., date, time, place, person(s), unit, device, facility, etc.).

The user interface may include a “design your own report” tool kit, which allows a user to create a report with many different format options (i.e., such as headers, logos, text type, charts, digital format, etc.). In specific environments, this could be tied to existing reports at a local level (i.e., such as those required by a hospital's accrediting organizations such as JCAHO), or can be made to conform to a variety of quality/performance/safety metrics. The user interface may include software that provides the capability to export data directly into a stakeholder's (i.e., payers, regulators, shareholders, etc.) existing reporting tools.

### Example 2

Another example of the present invention is directed to tracking and reporting hospital worker hand hygiene compliance in the crit care unit (CCU) of a hospital. In this example, the hospital may be specifically responding to a state requirement to track and formulate a report of the hand hygiene compliance of hospital workers who have clinical responsibilities in the CCU over the course of a predetermined time period. The hospital will be able to utilize the present invention for Medicare incentive funding opportunities long term after the hand hygiene pilot program.

In this example, if there is a central processing system 103 in addition to data gathering devices 101, as in the centralized embodiment, the central processing system 103 may run on its own hardware, and may be physically located in the secure hospital computer room in a nearby part of the hospital building. In the centralized embodiment, an independent and secure network is established to connect the data gathering devices 101 and feedback devices 120 to the central processing system 103, and supports access to the database(s) 113 or 114 by credentialed users via a web-based portal. In this embodiment, the program 110 is run by the central processing system 103. The administrator of the system accesses the program 110 through the same network 150 and user portal 102/104, with a level of access unique to the administrator.

In this embodiment, the customized data samples listed in the data sample catalog include pictures of each hospital worker who will be participating in the project. Facial or biometric recognition of each hospital worker in the CCD will be one of the types of data sample matches or correlations (observations). Further, the customized feedback commands may include customized audio responses (i.e., “Thank you Dr. Siegel”) for each hospital worker who will be participating in the pilot program).

In this embodiment, the administrator has set the access rights for each stakeholder in this pilot program to include: 1) reporting and query level access for the members of the quality assurance team that will be monitoring the hand hygiene compliance data and preparing reports; 2) “view only” access for each hospital worker participating in the hand hygiene pilot program. Thus, the hospital workers will be able to access their own data and also query the hand hygiene activities such that they can gauge their hand hygiene compliance against other participating hospital workers (not by name for privacy concerns).

In this example of a hospital CCU hygiene system, each hand hygiene station in the CCU includes, for example, two wall-mounted, self-drying soap dispensers in each of the patient rooms, four (4) in the main hallway of the unit, two (2) in the nursing station, and one (1) sink in the nursing station. Each hand hygiene system would include at least one data gathering devices 101 and at least one data feedback device 120 disposed proximate to the hand hygiene system. Each of the data gathering devices 101 (see FIG. 3) would include, for example, a camera 161 and/or microphone system 162 for facial recognition and/or voice recognition, respectively, and/or a badge scanning apparatus 163 which would detect the individual's badge in proximity to the hand hygiene apparatus.

In one embodiment, the feedback device 120 is incorporated in the same housing 165, and may include a visual display 166 (i.e., lights, digital signage, or a computer or display), and/or a speaker (for audio) 167.

The steps in this example are also correlated with the steps shown in FIG. 2 above. In step 201 (see FIG. 2), the program 110 would receive the data from the data gathering devices 101, would analyze the data, and would be able to make data sample correlations or matches with the data sample catalog in step 402, such as an identity of the individuals approaching the hand hygiene apparatus. The identity of the individuals would be determined by biometrics, such as visual means (i.e., facial recognition), and/or voice recognition, and/or identifying the individual by his/her motion (i.e., gait, movement), or physical characteristics (i.e., height, gender, weight, fingerprint, etc.), or by RFID badge etc.

The individual would conduct hand hygiene (i.e., washing with soap, using sanitizer) at a hand hygiene device or dispenser, and the data gathering devices 101 would sample the combination of hand motions made at the dispenser, and send the raw data to the processor 106 for matching and analysis in step 204. In particular, hand washing gestures that are sampled for compliance with hand washing protocols as stored in the feedback catalog, may include: 1) reaching for the soap dispenser, 2) wetting hands with clean running water (warm or cold), 3) applying soap from the dispenser, 4) rubbing hands together to lather and scrub them well, 5) scrubbing the hands, including the backs of the hands, between the fingers, and under the nails, 6) continuing the washing protocol for a predetermined duration (i.e., at least 20 seconds), 7) rinsing the hands well under running water for a predetermined number of seconds, and 8) drying hands using a clean paper towel.

In one embodiment, once the water is activated (i.e., sound recognition), the program 110 could analyze the data, and check this analyzed data sample against the data sample catalog, and when it correlates or matches, provide a timer for step 5) of the washing protocol. Also, the program 110 could check the feedback command catalog and issue an alert at the end of the timed period (i.e., light flash, bell chime, etc.).

Alternatively, with hand sanitation, the individual would be monitored as they reach for the dispenser, apply the sanitizer product from the dispenser to the palm of one hand (the label providing the correct amount), and rub the hands together, over all surfaces of the hands and fingers, until the hands are dry.

The program 110 would receive all this data from the data gathering devices 101, and would be able to analyze the data samples, and make correlations or matches of the analyzed data samples with the data sample catalog in step 205, such as an identity of the individuals approaching the hand hygiene apparatus, and whether steps in the hand washing or hand sanitizer protocols are omitted or performed in less than the required time period(s). The specific motions associated with hand washing and hand sanitizing would have already been stored as recognized gestures in the feedback catalog.

In addition, to analyzing the data samples for feedback, quality of the handwashing (in fact, the quality of any movements observed, such as teeth brushing, cleaning, or even of basic movements for individuals undergoing physical therapy, etc.), can be obtained by analyzing the duration of the handwashing, the amount of soap used, the direction of flow of water from arm to hand to fingertips, and coverage of both sides of the hands, for example.

In one embodiment, gestures can also be utilized by the program 110 to identify a particular individual (e.g., the individual selects a unique gesture to train the system to recognize his/her identity, or the type, sequence, of gestures is indicative of a particular individual). The gestures could also be utilized to communicate other types of information such as reason for hand washing (i.e., hands up for surgery, etc.).

As with all applications of the present invention, all analyzed data samples are location, date- and time-stamped by the program 110 for later retrieval and for inclusion in reports. However, the raw data may be discarded immediately or after a predetermined period, for privacy reasons.

In step 204, the program 110 would then search the feedback command catalog in the database 113, 114 to determine if there are any feedback commands associated with those matched observations from the data sample catalog, and in step 205, if there is such a command, to implement the feedback command immediately via the feedback devices 120, in step 206.

Compliance with the hand hygiene system would result in a feedback command which triggers the feedback device 120 to implement audio, such as a voice from a speaker 167 saying “Thank you Dr. Siegel”, an excerpt of music, or a tone (i.e., bell chime). A visual display 166 with a green light flash, or “smiley face” emoji, or graphical display with an emoticon, or text “Thank you”, could also be used. In one embodiment, a quality assessment may be provided immediately, such as “good”, or “please repeat”, or at a later time in a report (i.e., a numerical (50%, 80% etc.), or letter grade (i.e., B+, D, etc.).

However, if a hospital worker fails to comply with the hand washing procedure at all (i.e., entering the patient's room without utilizing the hand hygiene system within a predetermined period of time, or walking past the hand hygiene system without utilizing it within a certain period of time), or performing the hand hygiene system incorrectly or incompletely, then the program 110 can issue an alert to the feedback device 120, such as an audio (i.e., warning bell 167) at speaker 167, or visual (i.e., flashing red light 166) alert at a display. The hospital worker would then have a predetermined period of time to correct this error, or his/her name will be provided to administrators by the program 110, for reporting purposes (or for an immediate alert, if desired).

The program 110 may also send a text message or email to the hospital worker when the processor 106 records positive or negative hand hygiene behavior, which could serve as a “receipt” for feedback to the hospital worker, and to compare with hospital records. Thus, if the hospital worker is used to getting positive feedback whenever they use a sink or hand sanitation dispenser in an area covered by the system 100, any negative feedback for omitted or incomplete hand hygiene would alert them that they are not performing to the standards required for quality patient care.

Members of the quality assurance) team of the hospital can observe the hospital workers in real-time if desired. on a display accessed through a web portal (i.e., hand held tablet 151), or on a display 102 at the computer room of the hospital. Thus, the QA staff can ensure that the program 110 is capturing the data elements, and that the subsequent observations and feedback commands are being implemented and recorded in the database 113, 114.

The program 110 may provide an automated report to the QA team and administrators, via email for example, which identifies the hospital workers in compliance with the hand hygiene program, and those not in compliance, with the data on the quality of the hand hygiene performed by the individuals, the grade of that compliance (i.e., letter, number etc.), the efficiency percentages of the individuals, departments, categories of groups, etc., (i.e., which stations had the most compliance etc.), and other data. The QA team can monitor the reports from the program 110 regarding recorded observations and executed feedback commands on a predetermined (i.e., daily) basis. The administrators can utilize the reports to compare individual hospital worker compliance, as well as compliance trends across shifts and days of the week. The individuals may also be provided with the reports by administrators.

The QA team can provide its own comments in the report, if desired, notifying administrators of any errors in observations or feedback commands by the program 110, to increase efficiency. The administrator will be able to make adjustments to the system 100 to fix errors, such as one of the hospital workers not being recognized correctly. As noted above with the previous example, is a worker is not recognized, or not authorized to be in the CCU, the program 110 can assign a temporary identification to the apparent hospital worker, and in some cases, alert security (via electronic means, such as text message, visual display etc.), until the QA team or administrator identifies the person or removes the person from the area.

In this example, the QA Director may now prepare a mid-term progress report for the point of contact at the state's Medicaid department, with the results of the hand hygiene program. Through the reporting template created by the administrator (customized using the system's 100 customizable reporting template creator), the report can include the outcomes (to date) of the pilot program.

Thus, the present invention may be used to monitor a variety of different environments and provide real-time, immediate feedback to users, such that problems are addressed in a timely fashion.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of conducting surveillance on activities being performed, comprising:
collecting data samples using at least one data gathering device and transmitting said data samples to a processor;
analyzing said data samples using said processor;
correlating each of said analyzed data samples or a combination of said analyzed data samples, using said processor, within a predetermined accuracy, with corresponding data samples in a data sample catalog stored in a database controlled by said processor; and
issuing a feedback command using at least one feedback device, based on a correlation between said data samples and said corresponding data samples in said data sample catalog, on condition that said feedback command is associated with said correlation.

2. The method of claim 1, further comprising:
wherein said at least one feedback device is located proximate to, or combined with, said at least one data gathering device.

3. The method of claim 1, wherein said feedback command is proportionate to results of said correlation.

4. The method of claim 1, wherein said feedback command issues an audio alert or a visual alert.

5. The method of claim 1, wherein said processor performs in real-time.

6. The method of claim 1, further comprising:
repeating said feedback command until said feedback command is turned off by said processor based upon predetermined instructions, or based upon instructions of a system administrator.

7. The method of claim 1, further comprising:
recording said analyzed data samples continuously in said database, using said processor.

8. The method of claim 1, further comprising:
recording said correlation of said analyzed data samples with said data samples in said data sample catalog in said database, using said processor.

9. The method of claim 1, further comprising:
recording each said issued feedback command in said database, using said processor.

10. The method of claim 1, wherein said data gathering device is part of a system which includes at least one of a camera, microphone, measurement device, sensor, motion detector, or scanner.

11. The method of claim 10, wherein said data samples include one of still frame, video, sound, speech, measurement data, motion, or scanned data.

12. The method of claim 11, wherein said camera facilitates visual identification based on biometrics, including at least one of visual, voice, motion, gait, movement, gestures, or physical characteristics.

13. The method of claim 10, wherein individuals are not individually identified, but are categorized as a group.

14. The method of claim 11, wherein a temporary identity is assigned to an individual who is not identified after analysis of said data samples.

15. The method of claim 1, further comprising:
preparing a report, using said processor, including information on said analyzed data samples and said issued feedback command.

16. The method of claim 15, wherein said report includes a trend analysis.

17. The method of claim 15, wherein all analyzed data samples are location, date-stamped and time-stamped by said processor for later retrieval and for inclusion in said report.

18. The method of claim 1, further comprising:
notifying predetermined personnel by electronic means, of at least one of said correlation with data samples in said data sample catalog, or of said issuance of said feedback command.

19. The method of claim 1, wherein said data samples are discarded immediately or after a predetermined period of time.

20. The method of claim 1, wherein said processor is at least one of disposed in said data gathering device, or is disposed at a central processing system.

21. The method of claim 20, wherein said data gathering device is one of a plurality of data gathering devices which communicate with said central processing system over a network.

22. The method of claim 20, wherein said data gathering device is a stand-along device which includes a feedback command device.

23. An apparatus which conducts surveillance on activities being performed, comprising:
at least one data gathering device which collects data samples and transmits said data samples to a processor disposed in said at least one data gathering device or at a central processing system;
wherein said processor analyzes said data samples;
wherein each of said analyzed data samples or a combination of said analyzed data samples, using said processor, are analyzed within a predetermined accuracy, with corresponding data samples in a data sample catalog stored in a database controlled by said processor; and
at least one feedback device which issues a feedback command, based on a correlation between said data samples and said corresponding data samples in said data sample catalog, on condition that said feedback command is associated with said correlation.

24. The apparatus of claim 23, wherein said data gathering device is one of a plurality of data gathering devices which communicate with said central processing system over a network.

25. The apparatus of claim 23, wherein said data gathering device is part of a system which includes at least one of a camera, microphone, measurement device, sensor, motion detector, or scanner.

26. The apparatus of claim 24, wherein said data gathering device is a stand-along device which includes a feedback command device.

27. The apparatus of claim 23, wherein said at least one feedback device is located proximate to, or combined with, said at least one data gathering device.

28. The apparatus of claim 27, wherein said feedback command issues an audio alert or a visual alert.

29. An apparatus which conducts surveillance on activities being performed, comprising:
at least one memory which contains at least one program which comprises the steps of:
collecting data samples at at least one data gathering device and transmitting said data samples to a processor;
analyzing said data samples using said processor;
correlating each of said analyzed data samples or a combination of said analyzed data samples, using said processor, within a predetermined accuracy, with corresponding data samples in a data sample catalog stored in a database controlled by said processor; and
issuing a feedback command using at least one feedback device, based on a correlation between said data samples and said corresponding data samples in said data sample catalog, on condition that said feedback command is associated with said correlation; and
at least one processor which executes the program.

30. A non-transitory computer-readable medium containing executable code for implementing a surveillance system which conducts surveillance on activities being performed, comprising:
collecting data samples at at least one data gathering device and transmitting said data samples to a processor;
analyzing said data samples using said processor;
correlating each of said analyzed data samples or a combination of said analyzed data samples, using said processor, within a predetermined accuracy, with corresponding data samples in a data sample catalog stored in a database controlled by said processor; and
issuing a feedback command using at least one feedback device, based on a correlation between said data samples and said corresponding data samples in said data sample catalog, on condition that said feedback command is associated with said correlation.
